(19) United States
(12) Patent Application Publication
(10) Pub. No.: US 2019/0117350 A1
(43) Pub. Date: Apr. 25, 2019

(54) METHOD FOR DEFINING A DENTAL ARRANGEMENT

(71) Applicant: VITA ZAHNFABRIK H. RAUTER GMBH & CO. KG, Bad Säckingen (DE)

(72) Inventors: Urban Christian, Bad Säckingen (DE); Eva Kerschensteiner, Bad Säckingen (DE); Franz Egle, Bad Säckingen (DE)

(21) Appl. No.: 16/300,300

(22) PCT Filed: May 9, 2017
(86) PCT No.: PCT/EP2017/061047

§ 371 Date: Nov. 9, 2018

(30) Foreign Application Priority Data
May 11, 2016 (EP) 16169206.6

(51) Int. Cl. A61C 9/00; A61C 13/00

(52) U.S. Cl. CPC A61C 9/004; A61C 19/05; A61C 13/0004

(57) ABSTRACT

A method for defining a dental arrangement for the production of partial or full tooth prosthetics, comprising the steps: determining base points defined by coordinates of a lower jaw and/or an upper jaw; determining a transverse dimension and/or a skeletal class and/or type of bite on the basis of the coordinates determined for the lower jaw and/or the upper jaw, and selecting a suitable dental arrangement on the basis of the transverse dimension determined and/or the skeletal class determined and/or the type of bite determined

### BACKGROUND

### 1. Field of the Disclosure

The disclosure relates to a method for defining a dental arrangement for the production of full and/or partial dental prostheses.

### 2. Discussion of the Background Art

The standard of the provision of patients with partial or full dental prostheses is high today. A dentist prepares the situation to be treated at the patient, while the (partial) dental prosthesis is usually produced in an external laboratory or a practice laboratory by an orthodontist according to the dentist's specifications. Here, the quality of the prosthesis depends largely on the skilled craftsmanship of the orthodontist who has to consider the dentist's specifications while producing the prosthesis, as well as on the quality of these specifications.

Further, the preparation of the patient to be provided with a prosthesis often involves inconveniences for the patient. To be noted in this context are e.g. various sessions at the treating dentist, during which impressions of the situation to be treated have to be made, which serve the orthodontist as negative models. The subsequent further impressions are time-consuming and are often the reason for an imprecise execution of the prosthetic treatment. Typically, two or three impression sessions are required, before the orthodontist can start with the actual production of the prosthesis.

Usually, the dental arrangement is made by the orthodontist on a tooth by tooth basis. Different methods of arrangement, such as the arrangement according to Staub (see e.g. US 2010/151417 A1), provide the orthodontist with assistance in setting up an appropriate tooth arrangement. However, it is a drawback that an optimal fit has to be found for the individual teeth of the tooth arrangement, while at the same time the anatomic conditions of the patient have to be taken into account, as well as the interaction of the teeth in the upper jaw and those in the lower jaw. Due to the use of individual teeth as the starting point of the tooth arrangement, a great number of realization options exists and thus a great number of error sources that may lead to an incorrect tooth arrangement and may thus cause trouble to the patient.

WO 2011/066895 A1 relates to a method for the automated production of dental prostheses comprising the steps of providing a digital data set of the individual denture to be produced, digitally separating the model into dental arch and gingiva, producing the dental arch from ceramics and plastic material using cutting technology or producing the denture base using generative or ablative methods from predominantly (meth) acrylate-based plastic materials, connecting the dental arch and the gingival mass through bonding or joining or a combination of bonding and joining.

EP 1 864 627 A2 discloses a method for manufacturing a dental prosthesis according to a digitized virtual model, which reflects the maxillary situation, comprising the steps of providing a data record that reflects the maxillary situation and relationship, digital modeling of the tooth (automatically, as an option), creating a divided negative mold (rapid manufacturing) from the data from the digital tooth modeling, inserting the fabricated teeth/fabricated tooth units into the opened negative molds, closing the negative molds, and filling any remaining cavity with plastics for the prosthesis.

EP 1 444 965 A2 relates to a method for the production of dental prosthesis, with the steps of recording and digitizing (scanning) the 3-dimensional, anatomical relationships in the oral cavity; if applicable, recording and digitizing (scanning) the 3-dimensional data of bite molds incl. bite blocks; if applicable, recording the jaw data which are normally taken on the patient for adjusting the articulator; processing the data set obtained, such that the relevant anatomical structures are secure for a virtual tooth placement and a virtual model is obtained as a data set; followed by the selection of the 3-D data sets of fabricated, previously scanned-in teeth from a further data set; virtual placement of the teeth into the virtual model as a second data set, as well as either followed by transferring the virtual placement onto the model either by a positioning template (e.g. milled or rapid prototyped) or by direct placement of the fabricated teeth on the model, fixing the teeth on the model, fastening the prosthesis base, or, according to another alternative, followed by a direct manufacture of the prosthesis base—according to the data of the virtual tooth placement—with positioning aids for the final correct positioning and fixing of the fabricated teeth. This method for producing dental prostheses is extremely complex. In particular, the effort is great for producing a precise dental prosthesis.

It is an object of the disclosure to provide a method for defining a dental arrangement for the production of full or partial dental prostheses, which allows a satisfactory selection of the tooth arrangement to be made in the simplest manner possible.

### SUMMARY

First, the oral situation of the patient is determined. This can be done using known methods, e.g. by impressions and bite registration and/or by digital images and, if applicable, digitizing the oral situation of the patient. For example, when bite templates are used for the upper and the lower jaw, an impression is made of the current situation of a patient. The same can be digitized, with the negative of the bite template representing the actual oral situation of a patient, so that the same is represented in the computer. A corresponding representation of the oral situation of a patient can also be obtained by a direct digital scan of the situation of a patient. As a result, the actual oral situation of a patient is always represented in the computer. According to the disclosure, coordinates of defined base points of a lower and/or upper jaw are determined first. This is preferably done using the lower and/or upper jaw represented in the computer, i.e. the represented oral situation of a patient.

Based on the coordinate-defined base points it is possible to determine a transverse dimension and/or a skeletal class and/or a type of bite for the lower and/or the upper jaw. In this regard, it is particularly preferred that in particular two and particularly preferred three of these features are determined in a manner as detailed as possible. The more features are determined and the more detailed these features are determined, the higher the quality of the definition of the tooth arrangement is. A complete and complex measuring of the oral cavity of the patient is not required. The determination of the features is performed merely by detecting individual base points. Thereby, the method is fast and less complex.

In the next step a selection of a suitable tooth arrangement is made based on the data determined, i.e. based on the transverse dimension determined and/or the skeletal class determined and/or the type of bite determined. Here, the tooth arrangement can be selected from a plurality of possible tooth arrangements. In particular, it is no longer necessary to assemble individual teeth into a tooth arrangement. Rather, the correct tooth arrangement, which already includes optimally matching artificial teeth, is selected based on the data determined. Adapting the artificial teeth to each other within the tooth arrangement and the error sources connected thereto thereby become obsolete. In particular, also the bite function of the upper and the lower jaw relative to each other is taken into account, so that the selection of the suitable tooth arrangement already guarantees an optimal interaction of the teeth of the upper jaw and of the lower jaw, without extensive and complex adaptations becoming necessary. Due to the algorithmic selection of the suitable tooth arrangement it is in particular possible to reduce the number of patient sessions for fitting the (partial) dental prosthesis and to thereby reduce the effort for the patient and the dentist. At the same time, a dental prosthesis can thus be provided faster.

In a further step, the tooth arrangement determined, and thus the defined artificial teeth, are then inserted into a fabricated prosthesis base. The production of the prosthesis base may e.g. be effected using CAD/CAM system as described in WO 2015/078701.

In a particularly preferred embodiment of the disclosure the suitable tooth arrangement is selected from a plurality of predetermined tooth arrangements. These may be stored in a data base, for example. Thereby, the method for producing a (partial) dental prosthesis is significantly simplified and in particular accelerated, since it is no longer necessary to tediously search for individual teeth to subsequently combine them into a tooth arrangement.

In a particularly preferred embodiment of the disclosure the transverse dimension is determined as the distance between the lowest points of the alveolar ridge. This is done preferably based on the actual situation of the patient's upper and/or lower jaw as represented in the computer. In this regard, it is particularly preferred that the base points include the farthest mesial points of the retromolar triangles on the right and the left side of the lower jaw. The transverse dimension can then preferably be obtained from the distance between the two farthest mesial points.

Thus, the transverse dimension can preferably be determined by

$$\frac{{r}_{d} - {t}_{m m}}{2} = y \qquad ( eq . 1 )$$

where
tₘₘ is the transverse dimension,
r_{d} represents the distances between the mesial points of the retromolar triangle and y is the conversion factor.

In a preferred embodiment, the coordinates of the corresponding base points are determined, i.e. for determining the transverse dimension, the coordinates of the two most mesial points of the retromolar triangles are determined. Using Cartesian coordinates, the distance dᵣ is calculated by

dᵣ(rdr;rdl)=\sqrt{(x_{rdr}+x_{rdl})²+(y_{rdr}−y_{rdl})²+(z_{rdr}−z_{rdl})²} (eq. 2)

where x, y, z are the coordinates of the left (l) and the right (r) most mesial point, respectively.

In a preferred embodiment the skeletal classes are determined in addition to or instead of the determination of the transverse dimension, i.e. it is in particular determined whether a protrusive occlusion or a supraocclusion exists. For the determination of the skeletal class it is preferred to determine, in addition to the mesial points of the retromolar triangle, the lowest points of the oral vestibule on the right and the left side beside the labial frenulum of the lower jaw and to define these as additional base points.

Based in particular on these base points, an occlusal angle k_{c} and an occlusal height h are determined which are then used to determine the skeletal class.

Here, for determining the occlusal angle k_{c}, first a centerline can be determined between the two defined mesial points and the two lowest points of the oral vestibule. The second line is then defined by a connecting line between the center of the two lowest points of the oral vestibule and a point on the upper jaw, the point referred to as papilla incisive.

The distance between the center between the two lowest points of the oral vestibule and the point papilla incisive further defines the occlusal height h.

For the mathematical determination, the coordinates of the two mesial points rdr and rdl, as well as of the two lowest points of the oral vestibule mvr and mvl are defined as:

rdr (x_{rdr}; y_{rdr}; z_{rdr})

rdl (x_{rdl}; y_{rdl}; z_{rdl})

mvr (xₘᵥᵣ; yₘᵥᵣ; zₘᵥᵣ)

mvl (xₘᵥₗ; yₘᵥₗ; zₘᵥₗ) (eq. 3)

where x, y, z represent the coordinates and r means right and l means left.

The centers searched for

rdm (x_{rdm}; y_{rdm}, z_{rdm})

mvm (yₘᵥₘ; yₘᵥₘ; zₘᵥₘ) (eq. 4)

are calculated from

$$rdm ( \frac{{x}_{rdl} + {x}_{rdr}}{2} ; \frac{{y}_{rdl} + {y}_{rdr}}{2} ; \frac{{z}_{rdl} + {z}_{rdr}}{2} ) \\ mvm ( \frac{{x}_{mvl} + {x}_{mvr}}{2} ; \frac{{y}_{mvl} + {y}_{mvr}}{2} ; \frac{{z}_{mvl} + {z}_{mvr}}{2} ) \qquad ( eq . 5 )$$

Further, the coordinates of the point papilla incisiva pi (xₚᵢ; yₚᵢ; zₚᵢ) were determined. From this, it is possible to calculate the occlusal height h, as well as the occlusal angle k_{c} by

$$h ( mvm ; pi ) = \sqrt{{( {x}_{mvm} - {x}_{pi} )}^{2} + {( {y}_{mvm} - {y}_{pi} )}^{2} + {( {z}_{mvm} - {z}_{pi} )}^{2}} \\ a ( rdm ; pi ) = \sqrt{{( {x}_{rdm} - {x}_{pi} )}^{2} + {( {y}_{rdm} - {y}_{pi} )}^{2} + {( {z}_{rdm} - {z}_{pi} )}^{2}} \\ b ( rdm ; mvm ) = \sqrt{{( {x}_{rdm} - {x}_{mvm} )}^{2} + {( {y}_{rdm} - {y}_{mvm} )}^{2} + {( {z}_{rvm} - {z}_{mvm} )}^{2}} \\ kc = arccos ( \frac{{a}^{2} - {b}^{2} - {h}^{2}}{- 2 bh} ) \qquad ( eq . 6 )$$

Based on the values obtained for the occlusal angle k_{c} and the occlusal height h, a skeletal class can be defined automatically. This is done in particular by stored limit values. For example, the following is given in terms of skeletal class:

Normal occlusion (class 1): k_{c}>50° and ≤90°

Supraocclusion (class 2): k_{c}>90°

Protrusive occlusion (class 3): k_{c}≤50° (eq. 7)

Of course it is also possible to define intermediate classes so as to achieve a further refining of the method of the disclosure.

For an automatic determination of the type of bite, two interalveolar connecting angles α and β are determined. The angle α to be determined on the left side of the lower jaw can be calculated from

$$w ( rdl ; tl ) = \sqrt{{( {x}_{rdl} - {x}_{tl} )}^{2} + {( {y}_{rdl} - {y}_{tl} )}^{2} + {( {z}_{rdl} - {z}_{tl} )}^{2}} \\ q ( tl ; rdr ) = \sqrt{{( {x}_{tl} - {x}_{rdr} )}^{2} + {( {y}_{tl} - {y}_{rdr} )}^{2} + {( {z}_{tl} - {z}_{rdr} )}^{2}} \\ dr ( rdr ; rdl ) = \sqrt{{( {x}_{rdr} - {x}_{rdl} )}^{2} + {( {y}_{rdr} - {y}_{rdl} )}^{2} + {( {z}_{rdr} - {z}_{rdl} )}^{2}} \\ α = arccos ( \frac{{q}^{2} - {w}^{2} - {dr}^{2}}{- 2 wdr} ) \qquad ( eq . 8 )$$

where
w is the distance between the left, farthest mesial point and the left point tuber maxillae.

The angle β on the right side can be determined by

$$v ( rdr ; tr ) = \sqrt{{( {x}_{rdr} - {x}_{tr} )}^{2} + {( {y}_{rdr} - {y}_{tr} )}^{2} + {( {z}_{rdr} - {z}_{tr} )}^{2}} \\ p ( tr , rdl ) = \sqrt{{( {x}_{tr} - {x}_{rdl} )}^{2} + {( {y}_{tr} - {y}_{rdl} )}^{2} + {( {z}_{tr} - {z}_{rdl} )}^{2}} \\ dr ( rdr ; rdl ) = \sqrt{{( {x}_{rdr} - {x}_{rdl} )}^{2} + {( {y}_{rdr} - {y}_{rdl} )}^{2} + {( {z}_{rdr} - {z}_{rdl} )}^{2}} \\ β = arccos ( \frac{{q}^{2} - {v}^{2} - {dr}^{2}}{- 2 vdr} ) \qquad ( eq . 9 )$$

where
v is the distance between the right, farthest mesial point and the right point tuber maxillae.

The type of bite thus obtained from these calculations is

Normal occlusion: α and β≥80°

Bilateral crossbite: α and β<80°

Unilateral crossbite: α or β<80° (eq. 10)

In a particularly preferred embodiment of the disclosure the system suggests a selection of a suitable tooth arrangement based on the transverse dimension determined, the skeletal class determined and the type of bite determined. Using the method of the disclosure, the orthodontist or the dentist is presented with a selection of at most 2 to 5 arrangements from a large number of tooth arrangements that may comprise 10 to 20 tooth arrangements, the selected arrangements primarily differing by deviating in their aesthetic shape at the front.

Such a small number of possible arrangements is obtained on the one hand by the automatic calculation of the transverse dimension, the skeletal class and the type of bite, as well as in particular also by manual selection. Specifically, an occlusal concept and/or a tooth line and/or a tooth shape are selected manually.

For the occlusal concept, the user may preferably choose among a plurality of occlusal concepts. Specifically, the selection is made according to the following:
arrangement via buccal contacts
arrangement lingualized
arrangement according to Prof. Dr. Dr. Grunert
arrangement according to Prof. Dr. Gerber

In a preferred embodiment, the user is also presented with different tooth line combinations for the selection of the tooth line.

For example, these are:
VITAPAN PLUS® (anterior teeth) and VITA LINGOFORM® (lateral teeth)
VITAPAN EXCELL® (anterior teeth) and VITA LINGOFORM® (lateral teeth)
VITA VIONIC® (anterior and lateral teeth)

Preferably, the user is presented with a selection also for the tooth shape. For example, these are:
shape R (rectangular)
shape O (shovel-shaped)
shape T (triangular)

In a further preferred embodiment of the disclosure, by which the number and/or the quality of the arrangements presented after calculation can be reduced or improved, respectively, the selection of an anterior teeth set is made on the basis of the nose width. In this regard, it is sufficient to also input the nose width into the system. Here, the nose width is multiplied by a factor, if applicable. The factor is preferably in a range of ca.±2 mm.

A preferred embodiment of the disclosure will be described in detail hereinafter with reference to the accompanying drawings.

### BRIEF DESCRIPTION OF THE DRAWINGS

In the Figures:

FIG. 1 is a schematic flow diagram for the selection of an optimal arrangement for the patient with the aid of the method of the disclosure,

FIG. 2 is an overview of the filter criteria,

FIG. 3 is a schematic view of a digitized lower jaw with the base points to be determined,

FIG. 4 is a schematic view of a digitize upper jaw with the base points to be determined,

FIG. 5 is a schematic view of the digital lower jaw for the determination of the transverse dimension,

FIG. 6 is a table and a schematic drawing for the determination of the transverse dimension,

FIG. 7 is a schematic digital view of the lower jaw for the determination of the skeletal class,

FIG. 8 is a schematic side view of the digitized lower and upper jaw for the determination of the occlusal height h and the occlusal angle k_{c},

FIG. 9 is a schematic rear view of the digitized upper and lower jaws for the determination of the type of bite,

FIG. 10 is a schematic view for the determination of the set dimension, and

FIGS. 11 and 12 show examples for arrangements determined by means of the method of the disclosure.

### DETAILED DESCRIPTION OF THE PREFERRED EMBODIMENT

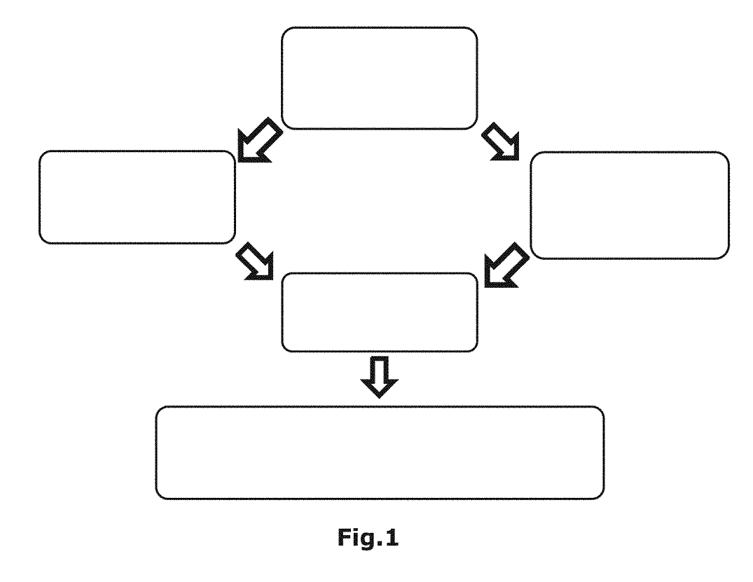

FIG. 1 schematically shows the essential process of selecting an ideal tooth arrangement. In a first step, the software is started, the software being a CAD software in particular. In doing so, in particular the digitized oral situation of a patient is read, which of course may also have been done at an earlier time already. In the next steps a manual selection of filter criteria is performed on the one hand and, on the other hand, an automatic determination of filter criteria is performed on the basis of calculations. All filter criteria are then used to filter the data base in which the plurality of tooth arrangements is stored. This results in a selection of only a few suitable tooth arrangements from which in particular the orthodontist can then choose. The tooth arrangements are artificial teeth already assembled into a (partial) row of teeth, which teeth are optimally matched to one another. Thus, it is no longer necessary to assemble individual teeth, but these are already included in the tooth arrangement.

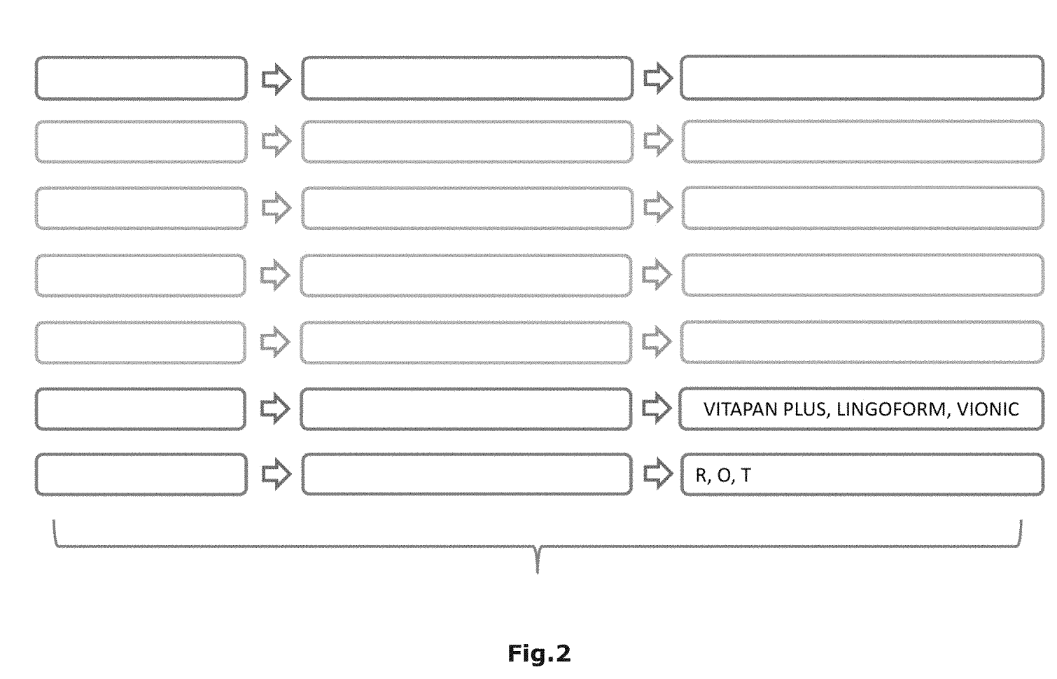

FIG. 2 shows an overview of the filter criteria. Here, the filter criteria labeled 1, 6 and 7 are filter criteria to be selected manually. These are the occlusal concept, the tooth line and the tooth shape, with examples of possible selections presented to the users being indicated on the right in FIG. 2.

For the determination of the set dimension, the user manually inputs the nose width, as will be explained in the following with reference to FIG. 10.

For determining the transverse dimension, the skeletal class and the type of bite, different base points or landmarks are input manually or are determined automatically by the system. Using the stored algorithms, the corresponding criteria are determined automatically.

The combination of all filter criteria is performed for the selection of the ideal arrangement based on a large number of different arrangements stored in a data base.

Base points or landmarks are defined for the individual calculations to be performed. For this purpose, the lower jaw is represented in the computer in a digitized manner as illustrated in FIG. 2. The two mesial points rdl and rdr on the left (l) and the right side (r) of the lower jaw are defined as the base points.

Further, the two lowest points mvr and mvl of the oral vestibule are defined on the right and the left side beside the labial frenulum.

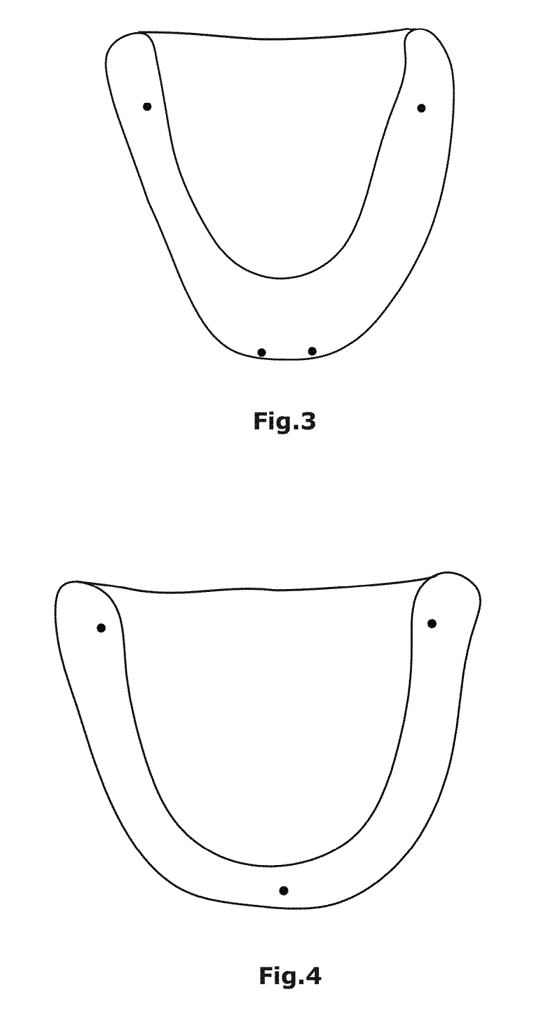

Since the upper jaw is also represented in the computer in a digitized form (FIG. 4), the left and right points tuber maxillae (tr, tl) are defined in addition. Moreover, the point papilla incisive (pi) is determined substantially on the side of the upper jaw opposite the labial frenulum of the lower jaw.

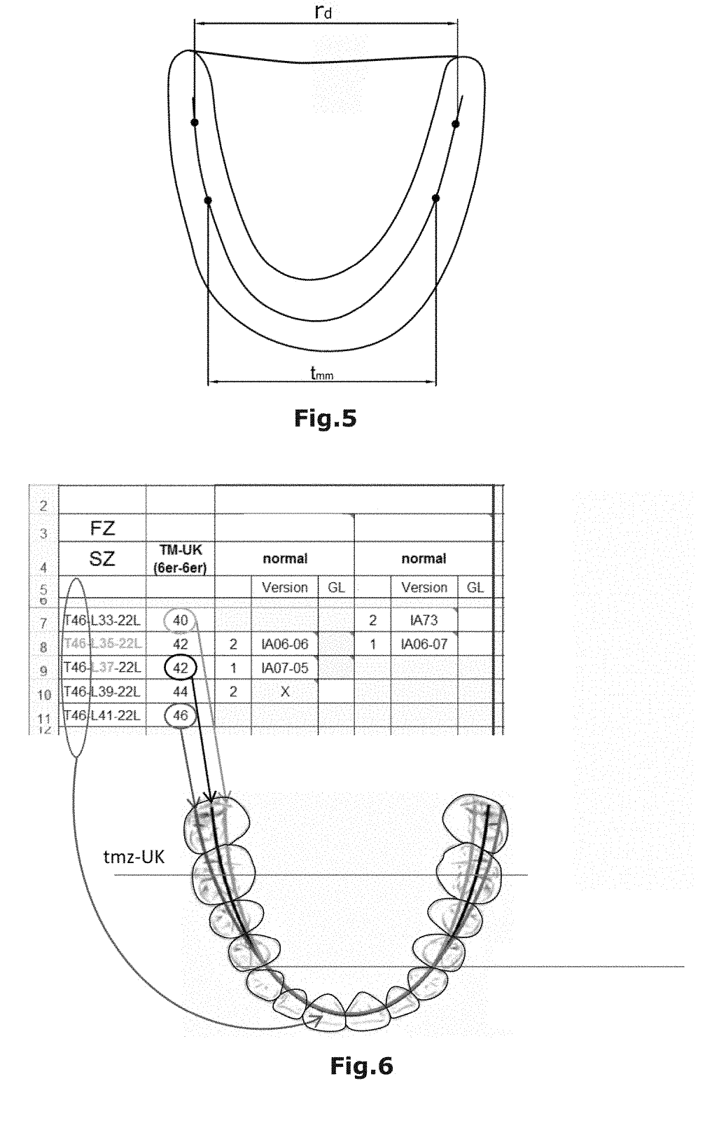

For the determination of the transverse dimension, the distance dᵣ is determined, as illustrated in FIG. 5. This is the distance between the two mesial points rdr and rdl. The distance r_{d} is then multiplied by a factor y to obtain the transverse dimension tₘₘ according to equation 1.

As illustrated in an exemplary manner in FIG. 6, an arrangement can be determined based on the transverse dimension determined. Here, arrangements having the same anterior teeth size may have different dental arch dimensions. In the embodiment illustrated, the transverse dimension of the arrangement tₘₐ, central fissure 36:45, is used via the filter criterion to select a suitable arrangement. Here, tₘₐ has to be within the determined transverse dimension tₘₘ±1.5 mm.

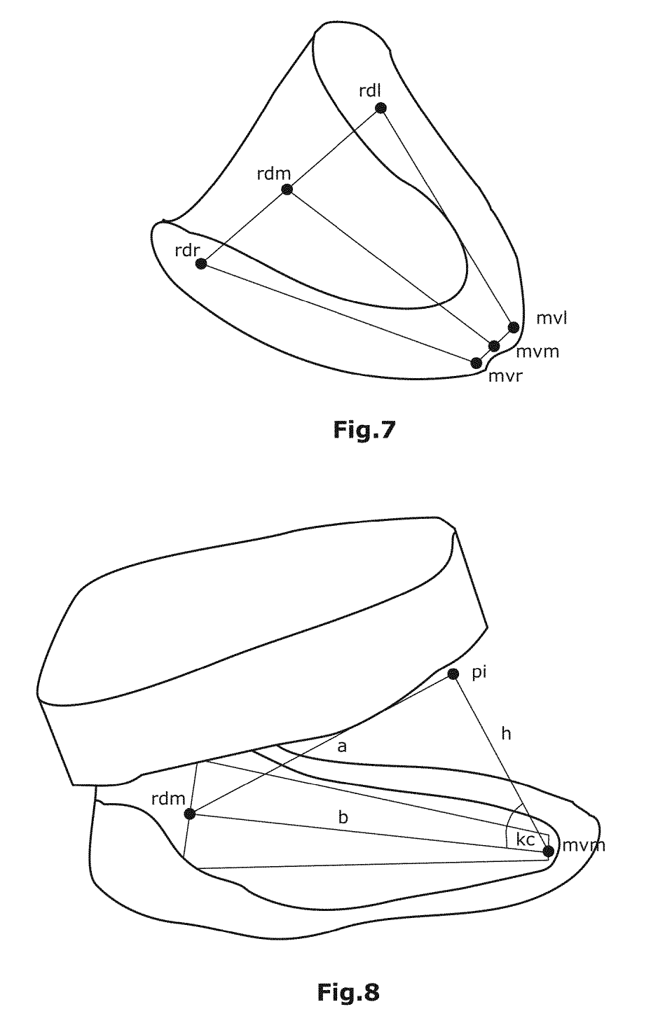

As illustrated in FIG. 7, for the determination of the skeletal class, first the two defined mesial points rdl and rdr are connected and the center rdm between these two points is determined. In a corresponding manner the two points in the oral vestibule mvr and mvl are connected with each other and their center mvm is determined as well. This results in a connecting line b. For the definition of a connecting line h (FIG. 8), the point mvm is connected with the point pi (FIG. 4) defined on the upper jaw. From this, the angle k_{c} is obtained. Further, a connecting line a is defined between the points rdm and pi. The angle is calculated using equation 6.

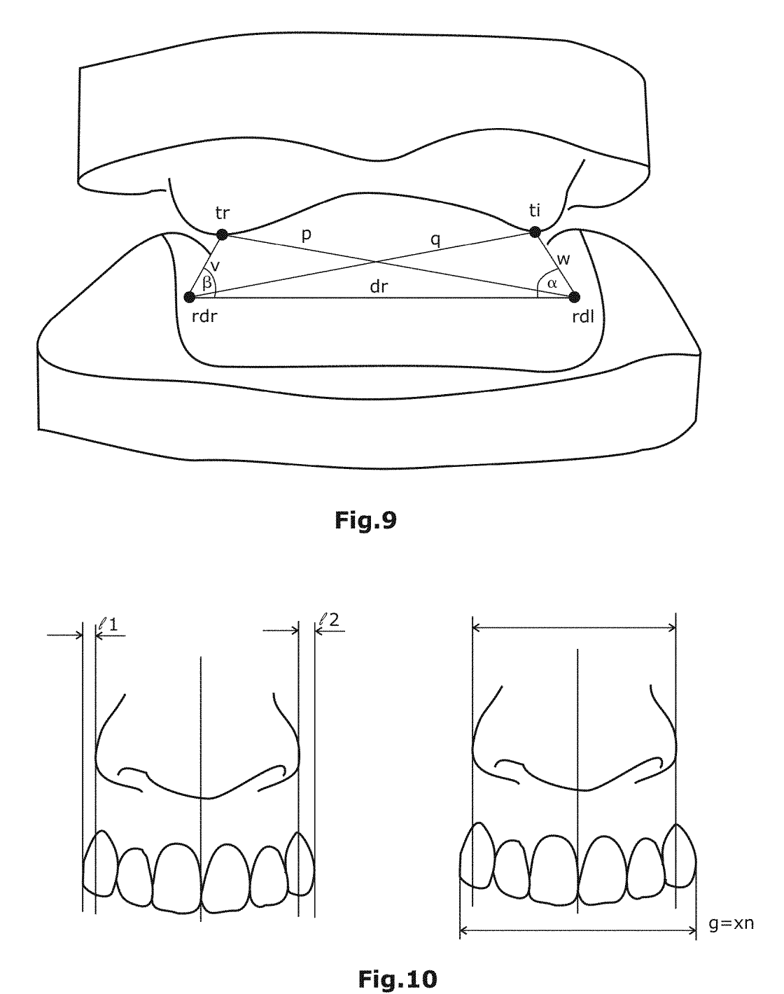

The calculation of the type of bite is performed using equation 8 and equation 9, as well as the geometry illustrated in FIG. 9. In addition to the distance dᵣ between the points rdr and rdl, the distances v between the points rdr and tr, as well as w between the points rdl and ti are defined. Further, the distances p between the points rdl and tr, as well as q between the points rdr and tl are defined. Thereafter, the angles α and β can be calculated from equations 7 and 8. From that, the type of bite is obtained.

For the determination of the set of anterior teeth the nose width n is measured (FIG. 10). I1+I2 is added to the nose width n, where I1, I2 typically are in a range from 0.5 to 3.5 mm. I1 and I2 correspond to the distance between an outer side of the nostril and an outer side of the canine tooth, as illustrated in FIG. 10. From this, the set dimension g is obtained according to the equation

g=I1+I2+n (eq. 11)

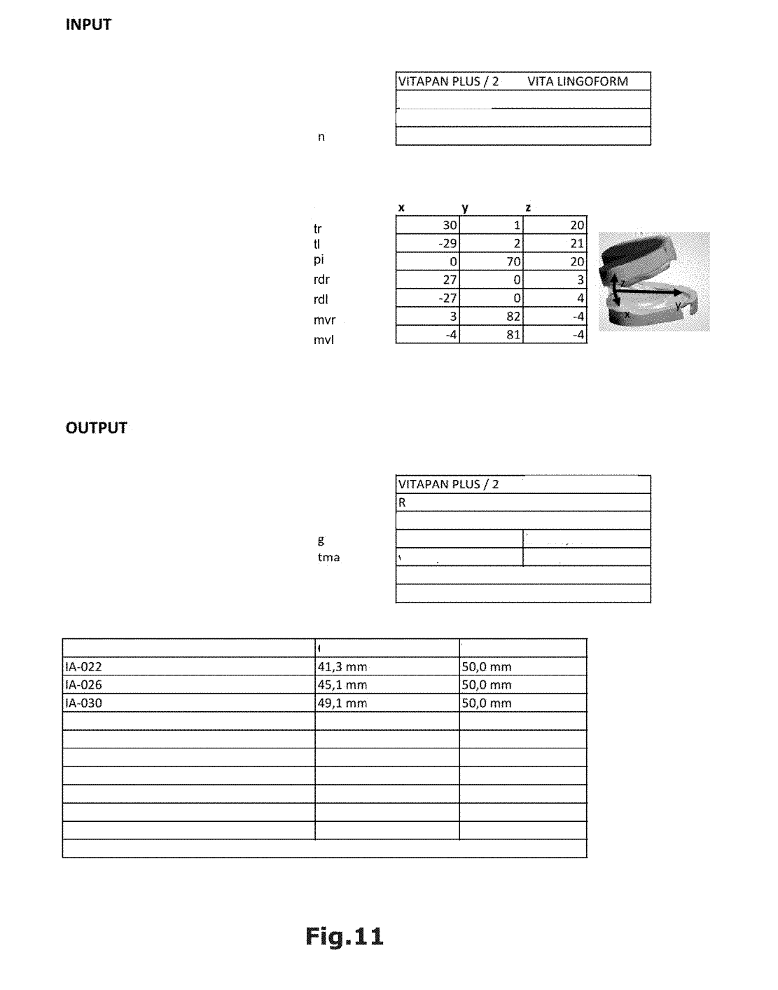

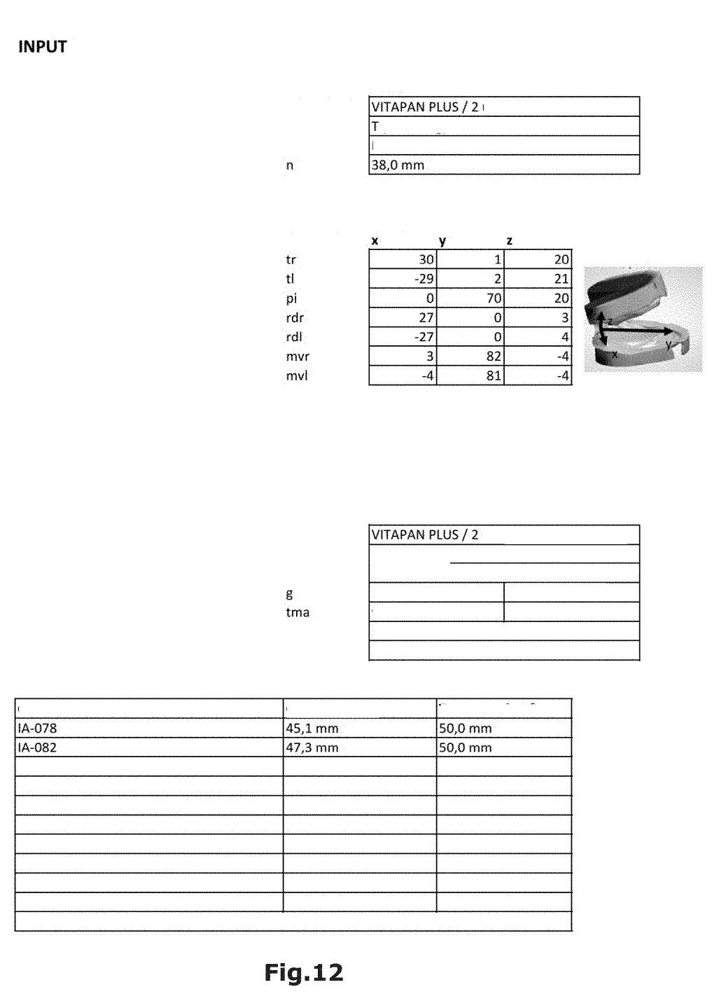

FIGS. 11 and 12 show examples of calculations. As the manual selection or input, the tooth line, the anterior teeth shape, the occlusal concept and the nose width are inputted.

Example: nose width 40 mm (center of canine tooth to center of canine tooth), tooth shape corresponding to type O

g=3.0+3.0+40 [mm]
g=46.0, substantially corresponding to O45

From the oral patient situations read into the CAD program or digitized, the landmarks or base points with the corresponding coordinates are obtained. Using the method of the disclosure, according to the example in FIG. 11, three or, according to the example in FIG. 12, two suitable arrangements are filtered from a plurality of arrangements stored in a data base. The orthodontist then merely has to choose among the determined suitable tooth arrangements. Sources of errors in the production of the (partial) dental prosthesis, e.g. due to incorrectly matched individual teeth, are eliminated altogether. The orthodontist is provided with an optimal starting point for the production of the (partial) dental prosthesis, without depending on the experience or the skilled craftsmanship of the orthodontist.

What is claimed is:

1. Method for defining a dental arrangement for the production of partial or full tooth prostheses, comprising the steps of:
determining base points of a lower jaw and/or an upper jaw, defined by coordinates;
determining a transverse dimension and/or a skeletal class and/or type of bite on the basis of the coordinates determined for the lower jaw and/or the upper jaw, and
selecting a suitable dental arrangement on the basis of the transverse dimension determined and/or the skeletal class determined and/or the type of bite determined.

2. Method of claim 1, wherein the base points include the farthest mesial points (rdl, rdr) of the retromolar triangles on the right and the left sides of the lower jaw.

3. Method of claim 1, wherein the base points include the lowest points (mvl, mvr) of the oral vestibule on the right and left sides beside the labial frenulum of the lower jaw.

4. Method of claim 1, wherein the base points include the points (tl, tr) tuber maxillae on the right and left sides of the upper jaw.

5. Method of claim 1, wherein the base points include the point (pi) papilla incisive of the upper jaw.

6. Method of claim 4, wherein the transverse dimension (tₘₘ) is determined at least on the basis of the distance (r_{d}) of the mesial points (tl, tr) of the retromolar triangle.

7. Method of claim 6, wherein the transverse dimension is multiplied by a correction factor (y).

8. Method of claim 1, wherein a skeletal class is determined on the basis of an occlusal angle (k_{c}) and an occlusal height (h).

9. Method of claim 8, wherein the occlusal angle (k_{c}) extends between a centerline (b) which extends in the middle (mdm, mvm) between the farthest mesial points (tdl, tdr) and the lowest points (mvl, mvr) of the oral vestibule, and a connecting line (h) to the point (pi) papilla incisive.

10. Method of claim 9, wherein the occlusal height (h) is determined as the distance between the center (mvm) of the two lowest points (mvl, mvr) in the oral vestibule and the point (pi) papilla incisive.

11. Method of claim 1, wherein the type of bite is determined based on the interalveolar connecting angles (α, β).

12. Method of claim 11, wherein the connecting angles (α, β) are determined by the connecting line (v, w, dr) between the two farthest mesial points (tr, tl) of the retromolar triangle and the left or right point (tr, tl) tubera, respectively.

13. Method of claim 11, wherein a normal occlusion is determined, if the two connecting angles are ≤80°, wherein a bilateral crossbite is determined, if the two connecting angles are ≥80°, and wherein a unilateral crossbite is determined, if only one of the two connecting angles is ≥80°.

14. Method of claim 1, wherein a set of anterior teeth is selected based on a nose width (n), wherein the nose width (n) is multiplied by a correction factor (x), if applicable.

15. Method of claim 1, wherein for the selection of a tooth arrangement for the lower jaw base and/or the upper jaw base, an occlusal concept and/or a tooth line and/or a tooth shape are selected.
